(19) United States
(12) Patent Application Publication
(10) Pub. No.: US 2016/0321949 A1
(43) Pub. Date: Nov. 3, 2016

(54) SWING SUPPORTING DEVICE, SWING SUPPORTING METHOD, SWING SUPPORTING SYSTEM, AND STORAGE MEDIUM

(71) Applicant: SEIKO EPSON CORPORATION, Tokyo (JP)

(72) Inventor: Takefumi SAYO, Shiojiri-shi (JP)

(73) Assignee: SEIKO EPSON CORPORATION, Tokyo (JP)

(21) Appl. No.: 15/135,936

(22) Filed: Apr. 22, 2016

(30) Foreign Application Priority Data
Apr. 30, 2015 (JP) 2015-093409

(51) Int. Cl. G09B 19/00; G06Q 30/02

(52) U.S. Cl. CPC G09B 19/0038; G06Q 30/0277

(57) ABSTRACT

An analyzer analyzes a predetermined indicator concerning a swing on the basis of information concerning a swing motion of at least one of an exercise instrument and a user who operates the exercise instrument. A selector selects, according to a result of the analysis of the indicator, a type of swing support information for supporting a swing of the user and outputs the type of the swing support information.

### BACKGROUND

1. Technical Field

The present invention relates to a swing supporting device, a swing supporting method, a computer program, a swing supporting system, and a storage medium.

2. Related Art

JP-A-2008-73210 discloses a technique for attaching a sensor to a golf club, analyzing swing behavior, and supporting evaluation of a swing.

Incidentally, a golf-swing analyzing device including an inertial sensor calculates swing speed, a track, and the like and presents a calculation result to a user.

However, it is difficult for the user to determine from the swing speed, the track, and the like whether the swing of the user is improved. Therefore, the user sometimes gets tired of the use of the golf-swing analyzing device.

Therefore, in order to allow the user to continuously use the golf-swing analyzing device, it is necessary to perform service development for keeping the motivation of the user.

### SUMMARY

An advantage of some aspects of the invention is to provide a technique that can achieve maintenance or improvement of the motivation of a user.

A first aspect of the invention is directed to a swing supporting device including: an analyzer configured to analyze a predetermined indicator concerning a swing on the basis of information concerning a swing motion of at least one of an exercise instrument and a user who operates the exercise instrument; and a selector configured to select, according to a result of the analysis of the indicator, a type of swing support information for supporting a swing of the user and output the type of the swing support information.

According to the first aspect, it is possible to achieve maintenance or improvement of the motivation of the user.

The indicator may be at least one of a tendency of the swing, the number of times of the swing, and a practice frequency of the swing per predetermined period.

With this configuration, it is possible to generate swing support information corresponding to at least one of a motion form of the swing, the number of times of the swing, and the practice frequency of the swing per predetermined period and provide the user with the swing support information.

The swing support information may include at least one of advice information of the swing, information concerning the exercise instrument suitable for the user, information concerning a practice ground where the user practices the swing, and information concerning a sales store that sells the exercise instrument.

With this configuration, the user can improve the swing of the user.

The selector may output coupon information as the swing support information when the indicator reaches or exceeds a predetermined threshold.

With this configuration, the user has motivation to swing in order to acquire the swing support information.

The swing support information may include identification information for identifying the user, and the swing supporting device may further include: an identification-information receiver configured to receive the identification information from a terminal device of the user; and a diagnosis-information transmitter configured to transmit, according to the received identification information, diagnosis information corresponding to the identification information to the terminal device of the user.

With this configuration, the user is capable of acquiring appropriate information concerning swing diagnosis information from another person.

The swing supporting device may further include: an advertisement-extraction-information generator configured to generate advertisement extraction information for extracting an advertisement related to the swing support information; and an advertisement-extraction-information transmitter configured to transmit the advertisement extraction information to the outside. The swing supporting device may receive advertisement information extracted on the basis of the advertisement extraction information from the outside and outputs the received advertisement information.

With this configuration, the user is capable of receiving an advertisement concerning the swing support information.

A second aspect of the invention is directed to a swing supporting method including: analyzing a predetermined indicator concerning a swing on the basis of information concerning a swing motion of at least one of an exercise instrument and a user who operates the exercise instrument; and selecting, according to a result of the analysis of the indicator, a type of swing support information for supporting a swing of the user and outputting the type of the swing support information.

According to the second aspect, it is possible to maintain or improve the motivation of the user.

A third aspect of the invention is directed to a computer program for causing a computer to execute: analyzing a predetermined indicator concerning a swing on the basis of information concerning a swing motion of at least one of an exercise instrument and a user who operates the exercise instrument; and selecting, according to a result of the analysis of the indicator, a type of swing support information for supporting a swing of the user and outputting the type of the swing support information.

According to the third aspect, it is possible to maintain or improve the motivation of the user.

A fourth aspect of the invention is directed to a swing supporting system including: an inertial sensor; a swing analyzing device configured to analyze, using an output of the inertial sensor, a swing motion of at least one of an exercise instrument and a user who operates the exercise instrument; and a swing supporting device including an analyzer configured to analyze a predetermined indicator concerning a swing on the basis of information concerning the swing motion and a selector configured to select, according to a result of the analysis of the indicator, swing support information for supporting a swing of the user and output the swing support information.

According to the fourth aspect, it is possible to maintain or improve the motivation of the user.

### BRIEF DESCRIPTION OF THE DRAWINGS

The invention will be described with reference to the accompanying drawings, wherein like numbers reference like elements.

FIG. 1 is a diagram showing a configuration example of a swing supporting system according to a first embodiment.

FIG. 2 is a diagram showing an example of functional blocks of a sensor unit and a swing analyzing device.

FIG. 3 is a diagram showing an example of functional blocks of a swing supporting device.

FIG. 4 is a diagram showing a data configuration example of a measurement-data storage.

FIG. 5 is a diagram showing a data configuration example of an exercise-information storage.

FIG. 6 is a diagram showing a data configuration example of a support-information storage.

FIG. 7 is a diagram showing a screen example of the swing analyzing device.

FIG. 8 is a flowchart for explaining an example of an operation for storing measurement data of the swing supporting device.

FIG. 9 is a flowchart for explaining an operation example of generation and transmission of swing support information of the swing supporting device.

FIG. 10 is a diagram showing another example of the data configuration example of the support-information storage.

FIG. 11 is a diagram showing another example of the data configuration example of the support-information storage.

FIG. 12 is a diagram showing a configuration example of a swing supporting system according to a second embodiment.

FIG. 13 is a diagram showing an example of functional blocks of a swing supporting device.

FIG. 14 is a diagram showing a screen example of a swing analyzing device.

FIG. 15 is a diagram showing a screen example of a terminal device.

FIG. 16 is a sequence chart showing an operation example of the swing supporting system.

FIG. 17 is a diagram showing a configuration example of a swing supporting system according to a third embodiment.

FIG. 18 is a diagram showing an example of functional blocks of a swing supporting device.

### DESCRIPTION OF EXEMPLARY EMBODIMENTS

Embodiments of the invention are explained below with reference to the drawings.

### First Embodiment

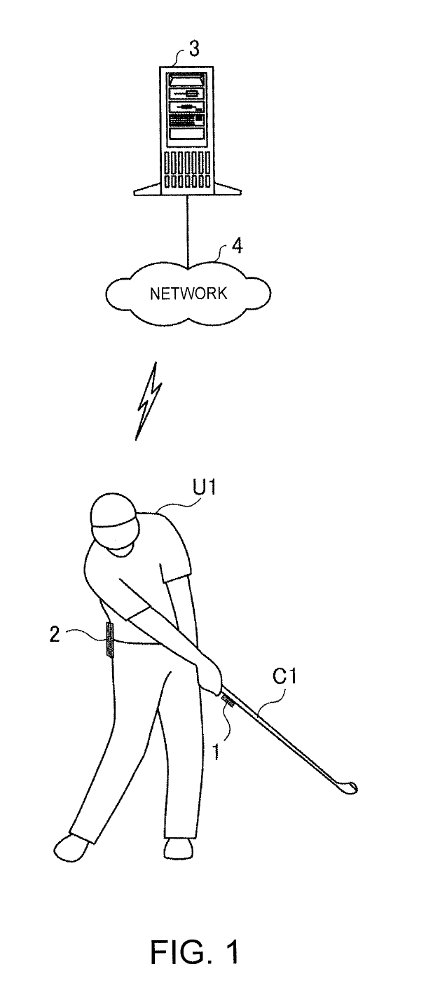

FIG. 1 is a diagram showing a configuration example of a swing supporting system according to a first embodiment. As shown in FIG. 1, the swing supporting system includes a sensor unit 1, a swing analyzing device 2, and a swing supporting device 3. A network 4 is the Internet or a wireless network of a cellular phone or the like. The swing analyzing device 2 and the swing supporting device 3 can perform communication with each other via the network 4. In FIG. 1, a golf club (equivalent to the exercise instrument according to the invention) C1 and a user U1 who swings the golf club C1 are shown.

The sensor unit 1 includes an inertial sensor and measures accelerations in axial directions of three axes, which are in a substantially orthogonal relation, and angular velocities generated around the three axes. For example, the sensor unit 1 is attached to a part of a shaft of the golf club C1 with a y axis among three detection axes of x, y, and z axes set in the longitudinal direction of the shaft of the golf club C1. The sensor unit 1 measures accelerations in the three axial directions of the golf club C1 and angular velocities around the three axes generated by a swing of the user U1. The sensor unit 1 transmits the generated accelerations and angular velocities (hereinafter sometimes referred to as measurement data) to the swing analyzing device 2, for example, by radio communication.

The swing analyzing device 2 is a terminal device such as a smartphone or a personal computer. In the example shown in FIG. 1, the swing analyzing device 2 is the smartphone and is attached to the waist of the user U1.

The swing analyzing device 2 receives the measurement data transmitted from the sensor unit 1 and analyzes a swing motion of the golf club C1 on the basis of the received measurement data. For example, the swing analyzing device 2 analyzes a swing motion such as a track (e.g., a track of a head) or head speed of the golf club C1. The swing analyzing device 2 transmits the measurement data measured by the sensor unit 1 to the swing supporting device 3 via the network 4.

The swing supporting device 3 is an information processing device such as a server. The swing supporting device 3 stores the measurement data measured by the sensor unit 1, which is transmitted from the swing analyzing device 2, in a storage device.

The user U1 can request, using the swing analyzing device 2, the swing supporting device 3 to transmit swing support information. The swing support information is information for supporting a swing of the user U1. The swing support information includes, for example, information concerning an advice and a lesson for improving the swing of the user U1 and information concerning a coupon.

When receiving the request for the swing support information from the user U1, the swing supporting device 3 analyzes a predetermined indicator (hereinafter referred to as swing indicator) concerning the swing of the user U1 on the basis of the measurement data of the user U1 stored in the storage device. For example, as the swing indicator analyzed by the swing supporting device 3, there is a swing type of the user U1. The swing supporting device 3 analyzes whether the swing of the user U1 is in a straight tendency, a hook tendency, or a slice tendency.

After analyzing the swing indicator of the user U1, the swing supporting device 3 generates swing support information for the user U1 on the basis of a result of the analysis. For example, when analyzing that the swing of the user U1 is in the slice tendency, the swing supporting device generates the swing support information including information concerning guidance of an advice and a lesson for improving the slice tendency and information concerning, for example, a coupon of the lesson.

The swing supporting device 3 transmits the generated swing support information to the swing analyzing device 2. The swing analyzing device 2 displays, on a display, the swing support information transmitted from the swing supporting device 3. Consequently, the user U1 can obtain the swing support information with respect to the present swing.

In this way, the swing supporting device 3 analyzes the predetermined indicator concerning the swing and generates, on the basis of a result of the analysis, the swing support information for supporting the swing of the user U1. The swing supporting device 3 transmits the generated swing support information to the swing analyzing device 2 used by the user U1. Consequently, when the user U1 swings the golf club C1 using the swing analyzing device 2, the user U1 can obtain information for supporting the swing of the user U1 from the swing supporting device 3. The user U1 has the motivation to continuously use the swing analyzing device 2.

Note that, in FIG. 1, the sensor unit 1 is attached to the golf club C1. However, the sensor unit 1 may be attached to a part of the body of the user U1. For example, the sensor unit 1 may be attached to an arm of the user U1 and measure a swing motion of the arm of the user U1.

In the above explanation, the swing supporting device 3 transmits the swing support information to the swing analyzing device 2. However, the swing supporting device 3 may transmit the swing support information to another terminal device managed or owned by the user U1.

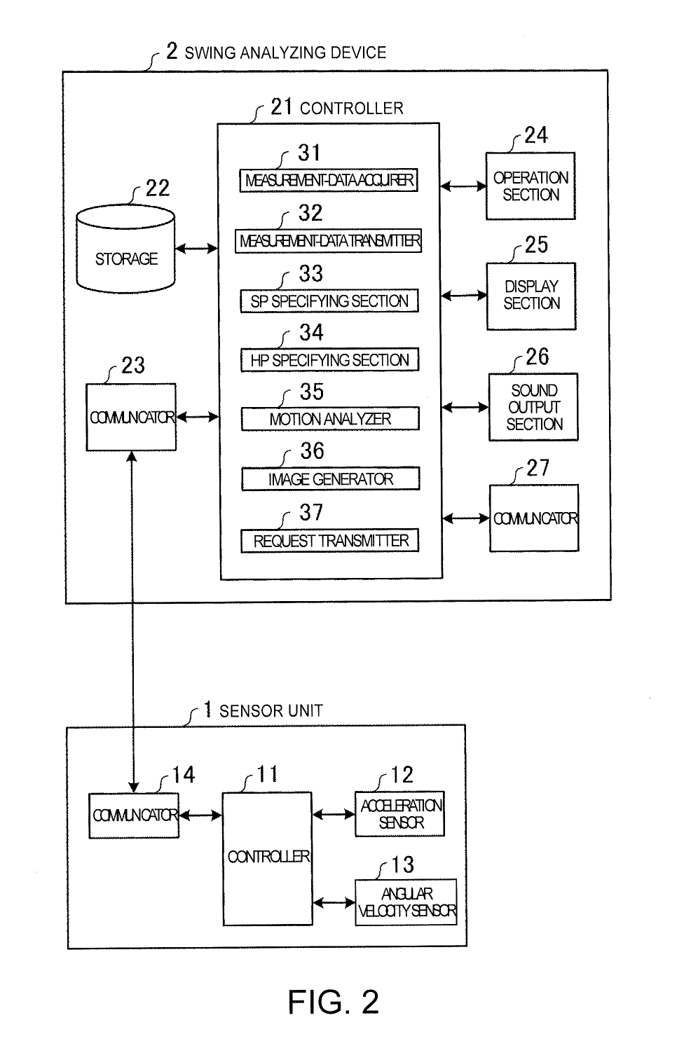

FIG. 2 is a diagram showing an example of functional blocks of the sensor unit 1 and the swing analyzing device 2. As shown in FIG. 2, the sensor unit 1 includes a controller 11, an acceleration sensor 12, an angular velocity sensor 13, and a communicator 14.

The controller 11 comprehensively controls the sensor unit 1. The controller 11 receives measurement data (acceleration data and angular velocity data) respectively from the acceleration sensor 12 and the angular velocity sensor 13, adds measurement time to the received measurement data, and outputs the measurement data to the communicator 14.

The acceleration sensor 12 measures accelerations respectively generated in three axial directions, which are in a substantially orthogonal relation. The acceleration sensor 12 outputs the measured accelerations to the controller 11 as, for example, a digital signal.

The angular velocity sensor 13 measures angular velocities generated around respective three axes, which are in a substantially orthogonal relation. The angular velocity sensor 13 outputs the measured angular velocities to the controller 11 as, for example, a digital signal.

The communicator 14 transmits the measurement data (including the measurement time) output from the controller 11 to the swing analyzing device 2. The communicator 14 receives a control command from the swing analyzing device 2 and outputs the received control command to the controller 11. The controller 11 performs various kinds of processing corresponding to the control command.

The swing analyzing device 2 includes a controller 21, a storage 22, a communicator 23, an operation section 24, a display section 25, a sound output section 26, and a communicator 27.

The controller 21 comprehensively controls the swing analyzing device 2. The controller 21 is realized by, for example, a computer including a CPU (Central Processing Unit), which is an arithmetic unit, a RAM (Random Access Memory), which is a volatile storage device, a ROM (Read Only Memory), which is a nonvolatile storage device, an interface circuit that connects the controller 21 and other units, and a bus that connects these devices. The controller 21 may be realized by an ASIC (Application Specific Integrated Circuit) or the like. The functional sections of the controller 21 are explained below.

In the storage 22, for example, data used for processing by the controller 21 is stored. The storage 22 can be realized by a nonvolatile storage device such as a flash ROM.

The communicator 23 receives measurement data transmitted from the sensor unit 1. The communicator 23 outputs the received measurement data to the controller 21. The communicator 23 receives a control command output from the controller 11. The communicator 23 transmits the received control command to the sensor unit 1.

The operation section 24 acquires operation data from a user. The operation section 24 outputs the acquired operation data to the controller 21. The operation section 24 is, for example, a touch panel provided on the display, buttons, keys, or a microphone.

The display section 25 displays a processing result of the controller 21 as characters, a graph, a table, an animation, or other images. The display section 25 is, for example, an LCD (liquid crystal display), an EPD

(Electrophoretic Display), a display including an organic light emitting diode (OLED), a touch panel display, or a HMD (head mounted display).

The sound output section 26 outputs the processing result of the controller 21 as voice or buzzer sound. The sound output section 26 is, for example, a speaker or a buzzer.

The communicator 27 performs communication with the swing supporting device 3 via the network 4.

The functional sections of the controller 21 are explained. The controller 21 includes a measurement-data acquirer 31, a measurement-data transmitter 32, an SP (shaft plane) specifying section 33, an HP (Hogan plane) specifying section 34, a motion analyzer 35, and an image generator 36. At least a part of the functional sections of the controller 21 can be realized by, for example, the CPU reading out a predetermined computer program stored in the ROM to the RAM and executing the predetermined computer program. The predetermined computer program is, for example, an application program running on an OS (operating system). The predetermined computer program can be read out from a portable storage medium and installed in the swing analyzing device 2 or downloaded from a server on a network and installed in the swing analyzing device 2. The OS and the application program may be stored in the storage 22.

The measurement-data acquirer 31 acquires the measurement data measured by the sensor unit 1, which is received by the communicator 23.

The measurement-data transmitter 32 outputs the measurement data acquired by the measurement-data acquirer 31 to the communicator 27. When outputting the measurement data, the measurement-data transmitter 32 adds user identification information for identifying the user to the measurement data. That is, the measurement-data transmitter 32 transmits the measurement data measured by the sensor unit 1 and the user identification information to the swing supporting device 3 via the communicator 27 and the network 4. Note that the user identification information is given, for example, when the user performs user registration in a company that manufactures and sells the swing analyzing device 2.

The SP specifying section 33 specifies a shaft plane of the user from the measurement data acquired by the measurement-data acquirer 31.

The HP specifying section 34 specifies a Hogan plane of the user from the measurement data acquired by the measurement-data acquirer 31.

The motion analyzer 35 calculates motion information concerning a swing motion of the user from the measurement data acquired by the measurement-data acquirer 31. For example, the motion analyzer 35 calculates head speed and a track of the golf club, a face angle at impact time, and the like. The motion analyzer 35 calculates (determines) a swing type of the user.

Note that, in the determination of the swing type, the motion analyzer 35 determines the swing type on the basis of, for example, a V zone sandwiched by the shaft plane specified by the SP specifying section 33 and the Hogan plane specified by the HP specifying section 34 and the calculated track of the golf club. For example, when a track of the golf club before impact (a track from a predetermined point in time to the impact) remains passing in the V zone, the motion analyzer 35 determines that the swing type of the user is a straight type. When the track of the golf club before the impact enters the V zone from the shaft plane, the motion analyzer 35 determines that the swing type of the user is a slice type. When the track of the golf club before the impact enters the V zone from the Hogan plane, the motion analyzer 35 determines that the swing type of the user is a hook type.

The image generator 36 performs processing for generating image data displayed on the display section 25. For example, the image generator 36 generates image data concerning the swing motion calculated by the motion analyzer 35. Specifically, the image generator 36 generates curve data indicating the track of the golf club calculated by the motion analyzer 35, polygon data of the shaft plane specified by the SP specifying section 33, and polygon data of the Hogan plane specified by the HP specifying section 34.

When the operation section 24 receives a request for swing support information from the user, the request transmitter 37 outputs the request for the swing support information to the communicator 27. That is, the request transmitter 37 transmits the request for the swing support information to the swing supporting device 3 via the communicator 27 and the network 4.

Note that the controller 21 can calculate motion information of a swing motion using a general technique. For example, the controller 21 calculates the motion information of the swing motion with the technique disclosed in JP-A-2015-2910.

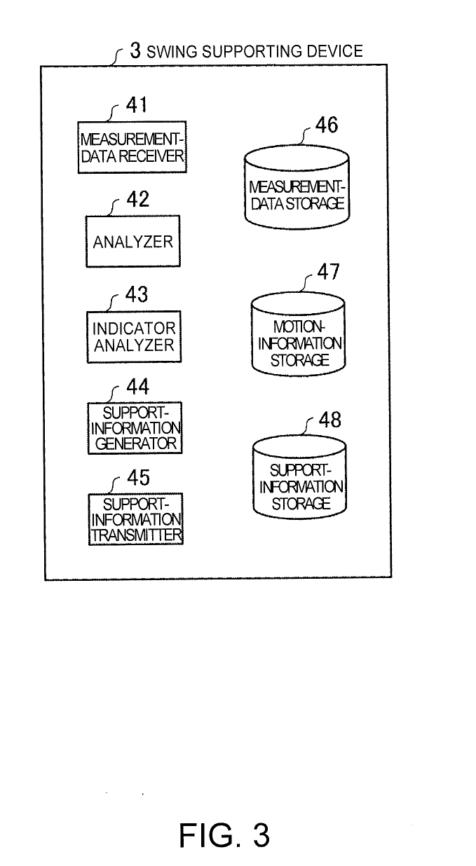

FIG. 3 is a diagram showing an example of functional blocks of the swing supporting device 3. As shown in FIG. 3, the swing supporting device 3 includes a measurement-data receiver 41, an analyzer 42, an indicator analyzer (equivalent to the analyzer according to the invention) 43, a support-information generator (equivalent to the selector according to the invention) 44, a support-information transmitter 45, a measurement-data storage 46, a motion-information storage 47, and a support-information storage 48.

The measurement-data receiver 41, the analyzer 42, the indicator analyzer 43, the support-information generator 44, and the support-information transmitter 45 of the swing supporting device 3 are realized by, for example, a computer including a CPU, which is an arithmetic unit, a RAM, which is a volatile storage device, an HDD (hard disk drive), which is a nonvolatile storage device, and a bus that connects these devices. A computer program executed by the CPU is stored in the HDD. The CPU exhibits a function of providing the user with the swing support information by, for example, loading the computer program to the RAM and executing the program. The measurement-data storage 46, the motion-information storage 47, and the support-information storage 48 of the swing supporting device 3 are realized by the CPU using the HDD or the RAM.

The measurement-data receiver 41 receives the measurement data (including the measurement time) and the user identification information transmitted from the swing analyzing device 2. The measurement-data receiver 41 distinguishes the received measurement data for each of users and stores the measurement data in the measurement-data storage 46.

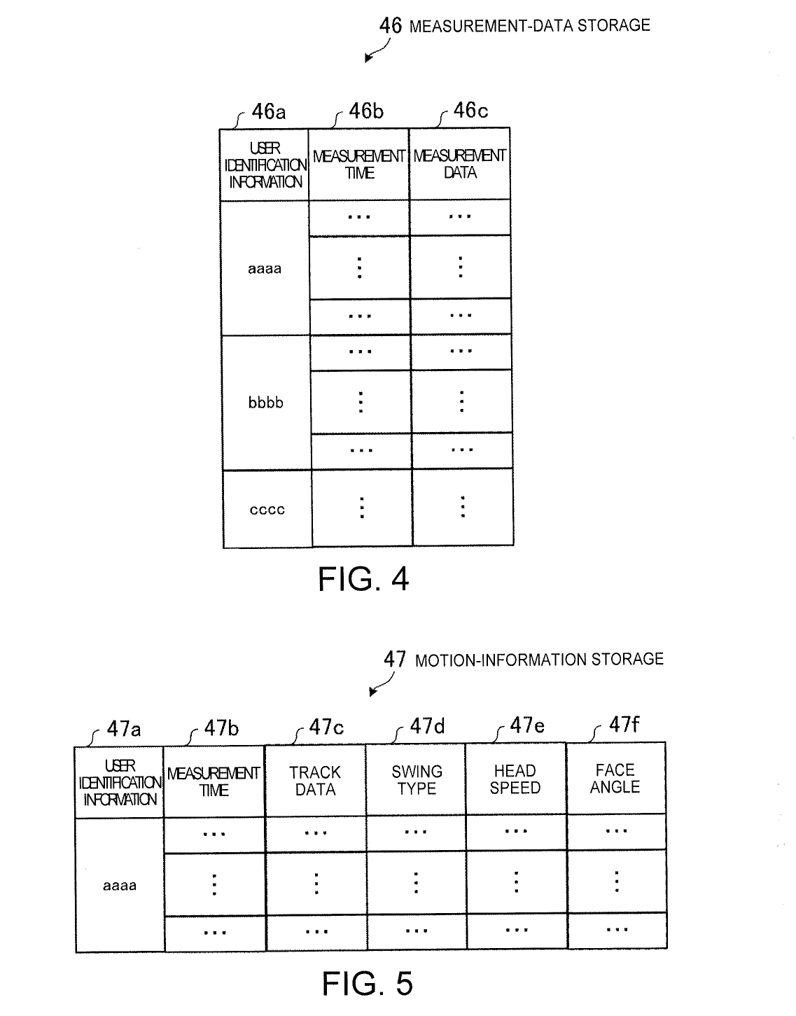

FIG. 4 is a diagram showing a data configuration example of the measurement-data storage 46. As shown in FIG. 4, in the measurement-data storage 46, user identification information 46a, measurement time 46b, and measurement data 46c are stored.

The user identification information 46a is identification information for identifying a user.

The measurement time 46b is measurement time when the sensor unit 1 of the user of the user identification information 46a corresponding to the measurement time 46b measures measurement data.

The measurement data 46c is data of acceleration and angular velocity measured by a sensor unit 1 of the user of the user identification information 46a corresponding to the measurement data 46c.

The measurement-data receiver 41 stores the received measurement time 46b and the received measurement data 46c for each piece of the user identification information 46a of users received from the swing analyzing device 2. Consequently, in the measurement-data storage 46, the measurement data 46c of each of the users and the measurement time 46b of the measurement data 46c are stored.

Referring back to FIG. 3, the analyzer 42 receives the request for the swing support information of the user transmitted from the swing analyzing device 2. When receiving the request for the swing support information, the analyzer acquires the measurement data of the user from the measurement-data storage 46 and analyzes the swing motion of the user. For example, the analyzer 42 acquires measurement data for a predetermined period such as one week in the past from the measurement-data storage 46 and analyzes, from the acquired measurement data, the swing motion of the user who requests the swing support information. Specifically, the analyzer 42 calculates a track, a swing type, head speed, a face angle, and the like of the golf club of the user who requests the swing support information.

Note that the analyzer 42 includes functions same as the SP specifying section 33, the HP specifying section 34, and the motion analyzer 35 explained with reference to FIG. 2. Like the SP specifying section 33, the HP specifying section 34, and the motion analyzer 35, the analyzer 42 analyzes the swing motion of the user who requests the swing support information.

The analyzer 42 stores the analyzed swing motion of the user for the predetermined time in the motion-information storage 47.

FIG. 5 is a diagram showing a data configuration example of the motion-information storage 47. As shown in FIG. 5, in the motion-information storage 47, user identification information 47a, measurement time 47b, track data 47c, a swing type 47d, head speed 47e, and a face angle 47f are stored. Motion information stored in the motion-information storage 47 is calculated for the predetermined period such as one week in the past and stored by the analyzer 42 as explained above.

The user identification information 47a is identification information of the user who requests the swing information.

The measurement time 47b is measurement time of measurement data, which is a calculation source of the motion information, of the user corresponding to the user identification information 47a. For example, the track data 47c, the swing type 47d, the head speed 47e, and the face angle 47f are calculated according to measurement data of the measurement time 47b corresponding thereto.

The track data 47c is data of a swing track of a swing of the golf club of the user corresponding to the user identification information 47a.

The swing type 47d is information concerning a swing type of the user corresponding to the user identification information 47a. As the swing type, there are a straight type, a slice type, and a hook type.

The head speed 47e is head speed of the swing of the golf club of the user corresponding to the use identification information 47a.

The face angle 47f is a face angle of the golf club at impact time of the user corresponding to the user identification information 47a.

Note that, in the motion-information storage 47 shown in FIG. 5, only motion information of one user is stored. However, depending on request timing of the swing support information from the user, motion information of a plurality of users is stored.

The motion information stored in the motion-information storage 47 is used for an analysis of the indicator analyzer 43 explained below. Therefore, the motion information stored in the motion-information storage 47 may be erased after the analysis of the indicator analyzer 43.

Referring back to FIG. 3, the indicator analyzer 43 analyzes a swing indicator concerning a swing on the basis of the motion information of the swing motion stored in the motion-information storage 47. For example, when a request for swing support information is received from a user and the motion information of the user is stored in the motion-information storage 47 by the analyzer 42, the indicator analyzer 43 analyzes a swing indicator of the user.

The swing indicator is a reference for evaluating or determining a swing of the user and is, for example, a motion form of a swing of a golf club. For example, the swing indicator is a motion form such as a swing type, head speed, and a face angle.

For example, the indicator analyzer 43 analyzes a tendency of the swing type of the user from the swing type for the predetermined period stored in the motion-information storage 47. The indicator analyzer 43 analyzes a tendency of the head speed of the user from the head speed for the predetermined period stored in the motion-information storage 47. The indicator analyzer 43 analyzes a tendency of the face angle at impact time from the face angle for the predetermined time stored in the motion-information storage 47.

More specifically, when most of swing types for one week of a user ‘aaaa’ stored in the motion-information storage 47 shown in FIG. 5 are the slice type, the indicator analyzer 43 analyzes that “a swing type of the user ‘aaaa’ is in a slice tendency”. In head speeds for one week of the user ‘aaaa’ stored in the motion-information storage 47, when the head speeds tend to increase but average head speed does not exceed a predetermined threshold, the indicator analyzer 43 analyzes that “the head speed of the user ‘aaaa’ tends to increases but does not exceed the threshold”. In face angles for one week of the user ‘aaaa’ stored in the motion-information storage 47, when a predetermined number of face angles exceeding a predetermined threshold are present, the indicator analyzer 43 analyzes that “the face angle of the user ‘aaaa’ tends to open”.

The support-information generator 44 generates, on the basis of an analysis result of the indicator analyzer 43, swing support information for improving the swing of the user. For example, the support-information generator 44 generates the swing support information referring to the support-information storage 48 on the basis of the analysis result of the indicator analyzer 43.

In the support-information storage 48, the analysis result of the swing indicator (the motion form) analyzed by the indicator analyzer 43 and the support information are stored in association with each other. Consequently, the support-information generator 44 can generate the swing support information corresponding to the analysis result of the indicator analyzer 43.

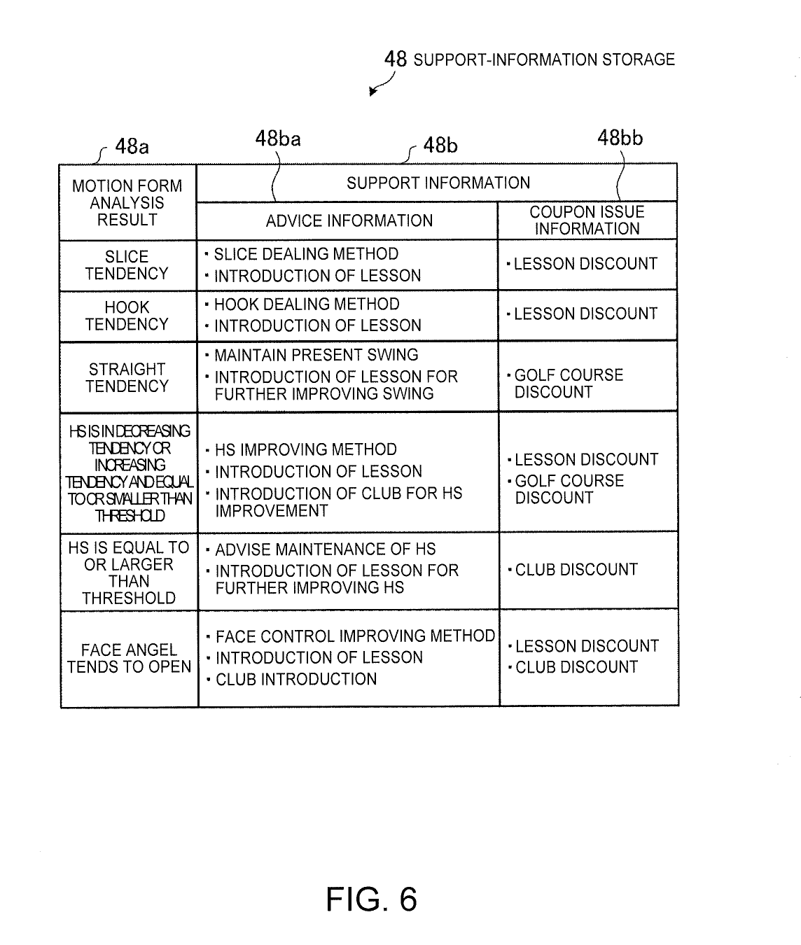

FIG. 6 is a diagram showing a data configuration example of the support-information storage 48. As shown in FIG. 6, in the support-information storage 48, a motion form analysis result 48a and support information 48b are stored. The support information 48b includes advice information 48ba and coupon issue information 48bb.

The motion form analysis result 48a is an analysis result of a swing indicator that the indicator analyzer 43 can output.

The advice information 48ba is advice information with respect to the analysis result of the indicator analyzer 43.

The coupon issue information 48bb is coupon issue information with respect to the analysis result of the indicator analyzer 43.

As explained above, the support-information generator 44 generates the swing support information referring to the support-information storage 48 on the basis of the analysis result of the indicator analyzer 43. For example, it is assumed that the indicator analyzer 43 analyzes that “a face angle of the user tends to open”. In this case, the support-information generator 44 acquires the advice information 48ba and the coupon issue information 48bb corresponding to the “the tendency of opening of the face angle” of the motion form analysis result 48a and the coupon issue information 48bb of the motion form analysis result 48a and generates the swing support information. More specifically, the support-information generator 44 acquires the advice information 48ba of a “face control improving method”, “introduction of a lesson” for face control, and “club introduction” for improving a face angle and the coupon issue information 48bb of “lesson discount” of the lesson to be introduced. The support-information generator 44 generates the swing support information on the basis of the information acquired from the support-information storage 48. That is, the support-information generator 44 selects, according to the analysis result of the indicator analyzer 43, a type of the swing support information for supporting the swing of the user and outputs the type of the swing support information.

Note that, in FIG. 6, to simplify explanation, the motion form analysis result 48a that the indicator analyzer 43 can output is indicated by sentences. However, the motion form analysis result 48a is indicated by, for example, a unique analysis number. For example, the indicator analyzer 43 outputs the analysis result of the analysis as an analysis number. The support-information generator 44 refers to the motion form analysis result 48a on the basis of the analysis number output by the indicator analyzer 43.

In FIG. 6, to simplify explanation, the advice information 48ba is indicated by a heading such as a “slice dealing method”. However, the advice information 48ba is specific information for improving a swing suitable for the user. For example, the advice information 48ba is text information for improving a slice or link destination data of a Web page that provides information for improving the slice.

In FIG. 6, to simplify explanation, the coupon issue information 48bb is indicated by a heading such as “discount of a lesson”. However, the coupon issue information 48bb is specific information for issuing a coupon suitable for the user. For example, the coupon issue information 48bb is text information indicating discount information of a lesson for improving a slice or link destination data of a Web page that provides the discount information of the lesson.

Referring back to FIG. 3, the support-information transmitter 45 transmits the swing support information generated by the support-information generator 44 to the swing analyzing device 2. Consequently, the user can obtain information for improving the present swing of the user.

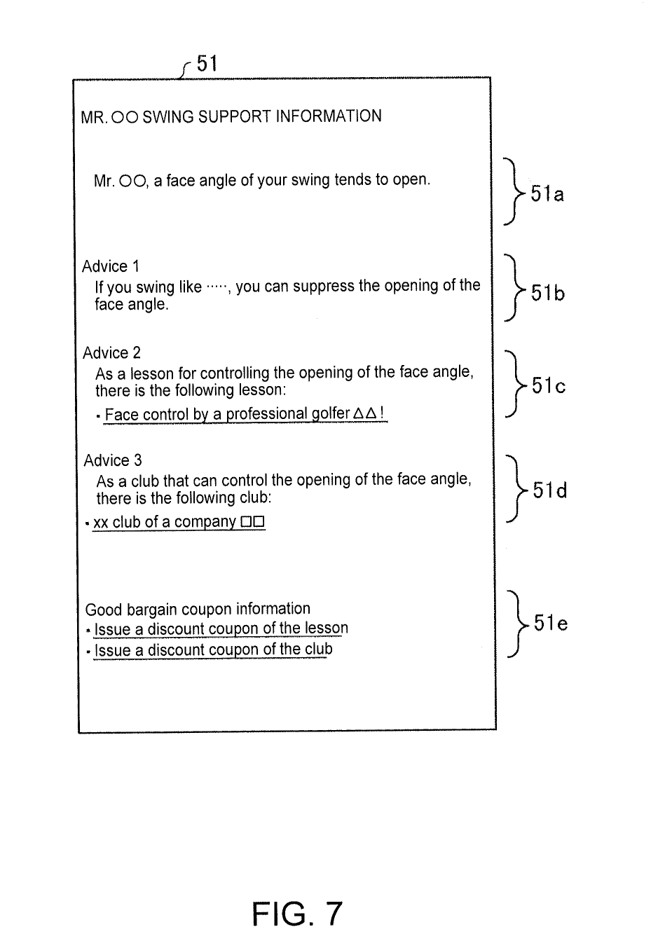

FIG. 7 is a diagram showing a screen example of the swing analyzing device 2. When the swing support information is transmitted from the swing supporting device 3 to the swing analyzing device 2, a screen 51 shown in FIG. 7 is displayed on the display of the swing analyzing device 2. The swing support information at the time when the face angle of the user tends to open is displayed on the screen 51.

An analysis result of the swing of the user is displayed in a region 51a of the screen 51. The analysis result in the region 51a is displayed on the basis of information of the “tendency of opening of the face angle” in the bottom column of the motion form analysis result 48a shown in FIG. 6.

In a region 51b, advice information for improving the opening of the face angle of the user is displayed. The advice information in the region 51b is displayed on the basis of information of the “face control improving method” of the bottom column of the advice information 48ba shown in FIG. 6.

In a region 51c, information concerning a lesson for improving the opening of the face angle of the user is displayed. A link is attached to an underlined character portion shown in the region 51c. When the user taps or clicks the underlined character portion, for example, the user can move to a Web page of a professional golfer who performs the lesson. The advice information in the region 51c is displayed on the basis of, for example, information of the “introduction of a lesson” in the bottom column of the advice information 48ba shown in FIG. 6.

In a region 51d, information concerning a golf club that can control the opening of the face angle of the user is displayed. A link is attached to an underlined character portion shown in the region 51d. When the user taps or clicks the underlined character portion, for example, the user can move to a Web page of a company that provides the golf club. The advice information in the region 51d is displayed on the basis of, for example, information of the “club introduction” in the bottom column of the advice information 48ba shown in FIG. 6.

In a region 51e, coupon information of the lesson and the club is displayed. A link is attached to an underlined character portion shown in the region 51e. When the user taps or clicks the underlined character portion, for example, the user can move to a Web page for issuing a coupon. The coupon information in the region 51e is displayed on the basis of information of the “lesson discount” and the “club discount” in the bottom column of the coupon issue information 48bb shown in FIG. 6.

The operation of the swing supporting device 3 is explained with reference to a flowchart.

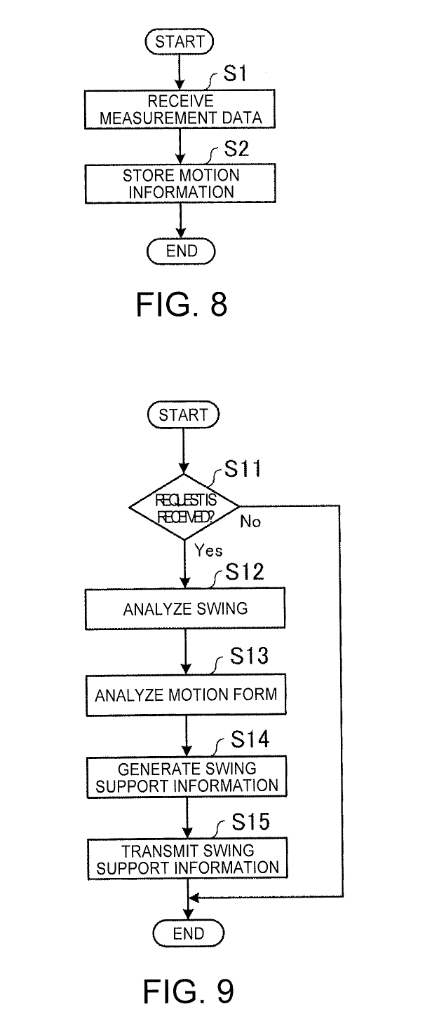

FIG. 8 is a flowchart for explaining an example of an operation for storing measurement data of the swing supporting device 3. When measurement data is transmitted from the swing analyzing device 2, the swing supporting device 3 executes processing of the flowchart shown in FIG. 8.

The measurement-data receiver 41 of the swing supporting device 3 receives the measurement data transmitted from the swing analyzing device 2 (step S1).

Subsequently, the measurement-data receiver 41 stores the measurement data received in step S1 in the measurement-data storage 46 (step S2).

According to the processing explained above, when the user wears the sensor unit 1 and the swing analyzing device 2 and swings the golf club, measurement data of the swing is stored in the measurement-data storage 46 of the swing supporting device 3.

FIG. 9 is a flowchart for explaining an operation example of generation and transmission of swing support information of the swing supporting device 3. The swing supporting device 3 repeatedly executes the processing of the flowchart shown in FIG. 8, for example, at a predetermined cycle.

The analyzer 42 determines whether a transmission request for swing support information is received from the swing analyzing device 2 (step S11). If the analyzer 42 receives the transmission request for swing support information from the swing analyzing device 2 (“Yes” in S11), the analyzer 42 shifts the processing to step S12. If the analyzer 42 does not receive the transmission request for swing support information from the swing analyzing device 2 (“No” in S11), the analyzer 42 ends the processing of the flowchart.

If the analyzer 42 receives the transmission request for swing support information in step S11 (“Yes” in S11), the analyzer 42 acquires, from the measurement-data storage 46, measurement data for a predetermined period of a user who requests the swing support information. The analyzer 42 analyzes, from the acquired measurement data, a swing motion of the user who requests the swing support information (step S12). The analyzer 42 stores motion information of the analyzed swing motion in the motion-information storage 47.

Subsequently, the indicator analyzer 43 analyzes a motion form of a swing (a swing indicator) on the basis of the motion information of the user who requests the swing support information (step S13). For example, the indicator analyzer 43 analyzes a tendency of a swing type, a tendency of head speed, a tendency of a face angle, and the like of the user.

Subsequently, the support-information generator 44 generates swing support information referring to the support-information storage 48 on the basis of an analysis result of the analysis in step S13 (step S14). For example, the support-information generator 44 generates image data of the screen 51 shown in FIG. 7.

Subsequently, the support-information generator 44 transmits the swing support information generated in step S14 to the swing analyzing device 2 (step S15). Consequently, for example, on the display of the swing analyzing device 2 of the user, the swing support information shown in the screen 51 in FIG. 7 is displayed.

In this way, the indicator analyzer 43 of the swing supporting device 3 analyzes a swing indicator on the basis of the motion information of the swing motion analyzed by the analyzer 42. The support-information generator 44 generates, on the basis of a result of the analysis of the swing indicator analyzed by the indicator analyzer 43, swing support information for supporting the swing of the user.

Consequently, when the user performs a swing using the swing analyzing device 2, the user can obtain, from the swing supporting device 3, information for improving the swing of the user. Therefore, it is possible to achieve maintenance or improvement of motivation to use the swing analyzing device 2.

The swing support information includes at least one of lesson information for improving the swing, information concerning a golf club, information concerning a golf practice ground or the like. Therefore, it is possible to achieve maintenance or improvement of motivation to use the swing analyzing device 2 of the user.

Note that, in the above explanation, the swing support information is generated according to the request from the user. However, the swing support information may be automatically generated at a predetermined cycle.

When the swing indicator reaches or exceeds a predetermined threshold, the support-information generator 44 may include coupon information in the swing support information. For example, the support-information generator 44 acquires the number of times of the swing of the user in a predetermined period such as one week in the past referring to the motion-information storage 47. When the acquired number of times of the swing exceeds a predetermined threshold, the support-information generator 44 acquires the coupon issue information 48bb of the support-information storage 48 and includes the coupon issue information 48bb in the swing support information. In this way, when the swing indicator exceeds the predetermined threshold, the swing support information includes good bargain information such as coupon information. Consequently, the user has motivation to perform the swing using the swing analyzing device 2. Note that one piece of the measurement time 47b of the motion-information storage 47 corresponds to one swing. Therefore, the support-information generator 44 can acquire the number of times of the swing from the number of pieces of the measurement time 47b of the motion-information storage 47. When the acquired number of times of the swing does not exceed the predetermined threshold, for example, the coupon information shown in the region 51e in FIG. 7 is not displayed on the display of the swing analyzing device 2.

When the analysis result of the swing indicator is a result determined in advance, the support-information generator 44 may include the coupon information in the swing support information. For example, when the analysis result of the swing indicator indicates that the swing indicator is good, for example, when the swing type of the user is in a straight tendency, the support-information generator 44 may include the coupon information in the swing support information. Consequently, the user has motivation to perform the swing using the swing analyzing device 2 and improve the swing of the user.

In the above explanation, the swing analyzing device 2 transmits measurement data to the swing supporting device 3. However, the swing analyzing device 2 may transmit the motion information of the swing motion obtained by analyzing the swing to the swing supporting device 3. In this case, the analyzer 42 of the swing supporting device 3 is unnecessary.

The sensor unit 1 may transmit the measurement data of the measurement to the swing supporting device 3 not via the swing analyzing device 2.

The swing support information may include information concerning a sales store that sells the golf club. For example, the swing support information may include a store name, access information, and a URL of the sales store that sells the golf club.

### Modification 1

In the above explanation, the motion form of the swing is explained as the example of the swing indicator. However, the swing indicator is not limited to this. For example, the swing indicator may be the number of times of the swing (e.g., an amount of practice) of the user.

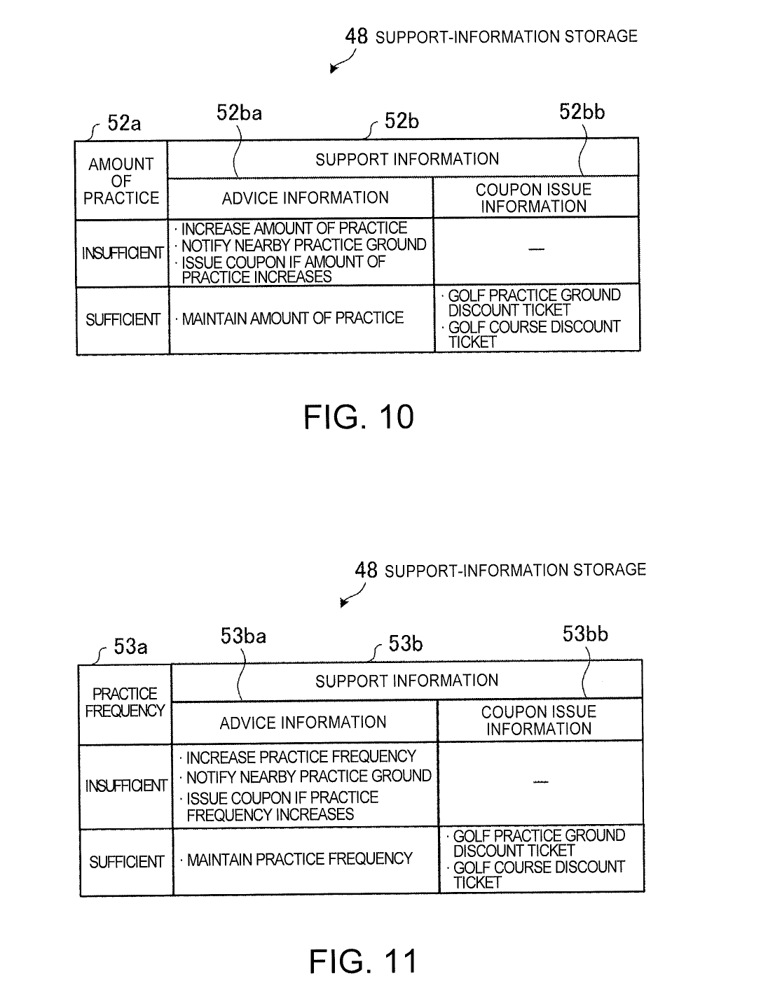

FIG. 10 is a diagram showing another example of the data configuration example of the support-information storage 48. As shown in FIG. 10, in the support-information storage 48, an amount of practice 52a and support information 52b are stored. The support information 52b includes advice information 52ba and coupon issue information 52bb.

The amount of practice 52a is an analysis result of an amount of practice that the indicator analyzer 43 can output. As the analysis result of the amount of practice that the indicator analyzer 43 can output, for example, there are analysis results indicating that the amount of practice is “sufficient” and “insufficient”.

The advice information 52ba is advice information with respect to the analysis result of the indicator analyzer 43.

The coupon issue information 52bb is coupon issue information with respect to the analysis result of the indicator analyzer 43. “-” in FIG. 10 indicates that there is no coupon information issued to the user.

The indicator analyzer 43 analyzes the swing indicator concerning the swing (the amount of practice) on the basis of the motion information of the swing motion stored in the motion-information storage 47. For example, the indicator analyzer 43 analyzes, referring to the motion-information storage 47, whether the amount of practice (the number of times of the swing) of the user, for example, for one week in the past is sufficient. Specifically, the indicator analyzer 43 determines whether the amount of practice of the user is smaller than a threshold or equal to or larger than the threshold and analyzes whether the amount of practice of the user is sufficient. Note that, as explained above, the amount of practice can be calculated from the number of pieces of the measurement time 47b stored in the motion-information storage 47.

The support-information generator 44 generates swing support information referring to the support-information storage 48 on the basis of the analysis result of the indicator analyzer 43. For example, it is assumed that the indicator analyzer 43 analyzes that “the amount of practice of the user is sufficient”. In this case, the support-information generator 44 acquires the advice information 52ba and the coupon issue information 52bb corresponding to the “sufficient” amount of practice 52a and generates the swing support information. More specifically, the support-information generator 44 acquires the advice information 52ba of “maintain the amount of practice” and the coupon issue information 52bb of “golf practice ground discount ticket” and “golf course discount ticket”. The support-information generator 44 generates the swing support information on the basis of the information acquired from the support-information storage 48.

In this way, the swing indicator to be analyzed may be the amount of practice of the user. Consequently, the user can obtain the swing support information from the swing supporting device 3 according to the amount of practice performed using the swing analyzing device 2. Therefore, it is possible to achieve maintenance or improvement of motivation to use the swing analyzing device 2.

Note that, in the case of the example shown in FIG. 10, as indicated by the coupon issue information 52bb, when the indicator analyzer 43 analyzes that the amount of practice is insufficient, the coupon information is not issued and, when the indicator analyzer 43 analyzes that the amount of practice is sufficient, the coupon information is issued. Therefore, the user has motivation to increase the amount of practice to obtain the coupon information.

Modification 2

The swing indicator may be a swing frequency (e.g., a practice frequency) of the user. The practice frequency is, for example, the number of days when the user performs swings in a predetermined period such as one week.

FIG. 11 is a diagram showing another example of the data configuration example of the support-information storage 48. As shown in FIG. 11, in the support-information storage 48, a practice frequency 53a and support information 53b are stored. The support information 53b includes advice information 53ba and coupon issue information 53bb.

The practice frequency 53a is an analysis result of a practice frequency that the indicator analyzer 43 can output. As the analysis result of the practice frequency that the indicator analyzer 43 can output, for example, there are analysis results indicating that the practice frequency is “sufficient” and “insufficient”.

The advice information 53ba is advice information with respect to the analysis result of the indicator analyzer 43.

The coupon issue information 53bb is coupon issue information with respect to the analysis result of the indicator analyzer 43. “-” in FIG. 11 indicates that there is no information concerning a coupon issued to the user.

The indicator analyzer 43 analyzes the swing indicator concerning the swing of the user (the practice frequency) on the basis of the motion information stored in the motion-information storage 47 by the analyzer 42. For example, the indicator analyzer 43 analyzes, referring to the motion-information storage 47, whether the practice frequency of the user for one week in the past is sufficient. Specifically, the indicator analyzer 43 determines whether the number of days when the user performs practice in a predetermined period such as one week is smaller than a threshold or equal to or larger than the threshold and analyzes whether the practice frequency of the user is sufficient. Note that the practice frequency can be calculated from the measurement time 47b stored in the motion-information storage 47.

The support-information generator 44 generates swing support information referring to the support-information storage 48 on the basis of the analysis result of the indicator analyzer 43. For example, it is assumed that the indicator analyzer 43 analyzes that “the practice frequency of the user is sufficient”. In this case, the support-information generator 44 acquires the advice information 53b and the coupon issue information 53bb corresponding to the “sufficient” practice frequency 53a and generates the swing support information. More specifically, the support-information generator 44 acquires the advice information 53ba of “maintain the practice frequency” and the coupon issue information 53bb of “golf practice ground discount ticket” and “golf course discount ticket”. The support-information generator 44 generates the swing support information on the basis of the information acquired from the support-information storage 48.

In this way, the swing indicator to be analyzed may be the practice frequency of the user. Consequently, the user can obtain the swing support information from the swing supporting device 3 according to the frequency of the practice performed using the swing analyzing device 2. Therefore, it is possible to achieve maintenance or improvement of motivation to use the swing analyzing device 2.

Note that, in the case of the example shown in FIG. 11, as indicated by the coupon issue information 53bb, when the indicator analyzer 43 analyzes that the practice frequency is insufficient, the coupon information is not issued and, when the indicator analyzer 43 analyzes that the practice frequency is sufficient, the coupon information is issued. Therefore, the user has motivation to increase the practice frequency to obtain the coupon information.

In the above explanation, the examples of the swing indicator are separately explained as the motion form of the swing, the amount of practice, and the practice frequency. However, these swing indicators may be combined. For example, the indicator analyzer 43 may analyze the motion form of the swing and the amount of practice of the user from the motion information of the swing motion analyzed by the analyzer 42. The support-information generator 44 may generate the swing support information on the basis of the analysis result of the motion form of the swing and the analysis result of the amount of practice of the user.

The swing indicator may be a frequency of use of the swing analyzing device 2. The frequency of use is, for example, the number of times the swing analyzing device 2 is used in a predetermined period such as one week. Specifically, the frequency of use is the number of times a power supply of the swing analyzing device 2 is turned on in the predetermined period.

### Second Embodiment

In a second embodiment, motion information concerning a swing motion of a user is transmitted to a terminal device managed by another person. For example, the motion information concerning the swing motion of the user is transmitted to a terminal device managed by a lesson professional or a terminal device managed by a golf shop. Consequently, for example, the user can take an appropriate lesson from the lesson professional or can be recommended an appropriate golf club from the golf shop.

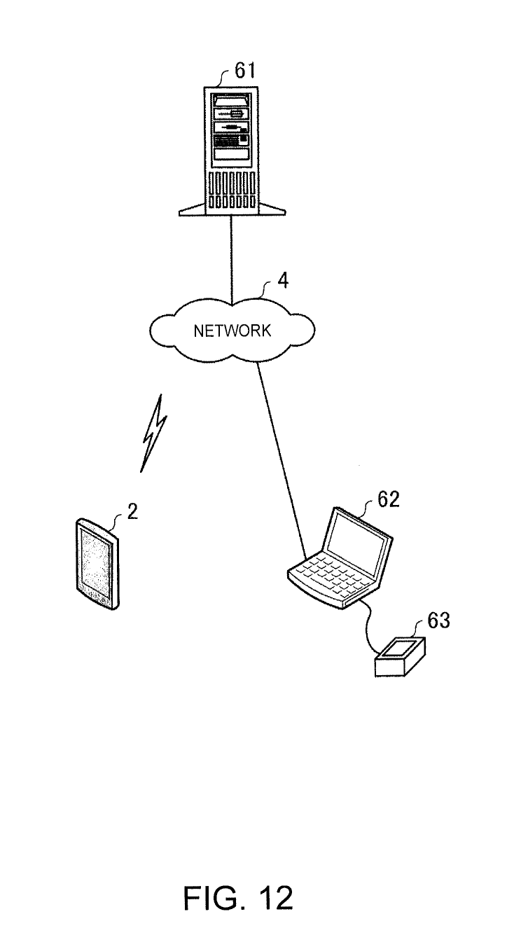

FIG. 12 is a diagram showing a configuration example of a swing supporting system according to the second embodiment. In FIG. 12, devices same as the devices shown in FIG. 1 are denoted by the same reference numerals and explanation of the devices is omitted. In FIG. 12, a swing supporting device 61, the swing analyzing device 2, a terminal device 62, and a reader 63 connected to the terminal device 62 are shown. In FIG. 12, the user U1, the golf club C1, and the sensor unit 1 are not shown.

The swing supporting device 61 has functions same as the functions of the swing supporting device 3 explained in the first embodiment. However, when generating swing support information provided to the user UI, the swing supporting device 61 includes identification information for identifying the user UI in the swing support information. For example, the swing supporting device 61 includes a two-dimensional code having the user identification information of the user U1 in the swing support information.

The terminal device 62 is, for example, a terminal device managed by a lesson professional. Alternatively, the terminal device 62 is, for example, a terminal device managed by a golf shop. The terminal device 62 is, for example, a smartphone or a PC.

The reader 63 is, for example, a reading device that reads identification information such as a two-dimensional code. The reader 63 is connected to the terminal device 62 and outputs the read identification information to the terminal device 62.

The schematic operation of the swing supporting system shown in FIG. 12 is explained. It is assumed that the swing supporting device 61 generates swing support information according to a request of the user UI and transmits the swing support information to the swing analyzing device 2. The swing support information transmitted by the swing supporting device 61 includes user identification information for identifying the user UI. The identification information for identifying the user UI is indicated by, for example, a two-dimensional code.

It is assumed that the user UI visits, for example, the lesson professional on the basis of advice information included in the swing support information and holds the two-dimensional code included in the swing support information over the reader 63 managed by the lesson professional.

The identification information of the user UI read by the reader 63 is transmitted to the swing supporting device 61 via the terminal device 62. The swing supporting device 61 acquires motion information of a swing motion of the user UI on the basis of the received user identification information of the user U1 and generates diagnostic information (equivalent to the diagnosis information according to the invention) indicating a swing state of the user UI.

The swing supporting device 61 transmits the generated diagnostic information to the terminal device 62. The terminal device 62 displays, on the display, the diagnostic information of the user UI transmitted from the swing supporting device 3.

Consequently, the lesson professional can give an appropriate lesson to the user UI on the basis of the diagnostic information of the user UI displayed on the terminal device 62.

Note that the same applies when the terminal device 62 is managed in the golf shop. For example, a store clerk of the golf shop can recommend an appropriate golf club to the user UI on the basis of the diagnostic information of the user UI displayed on the terminal device 62.

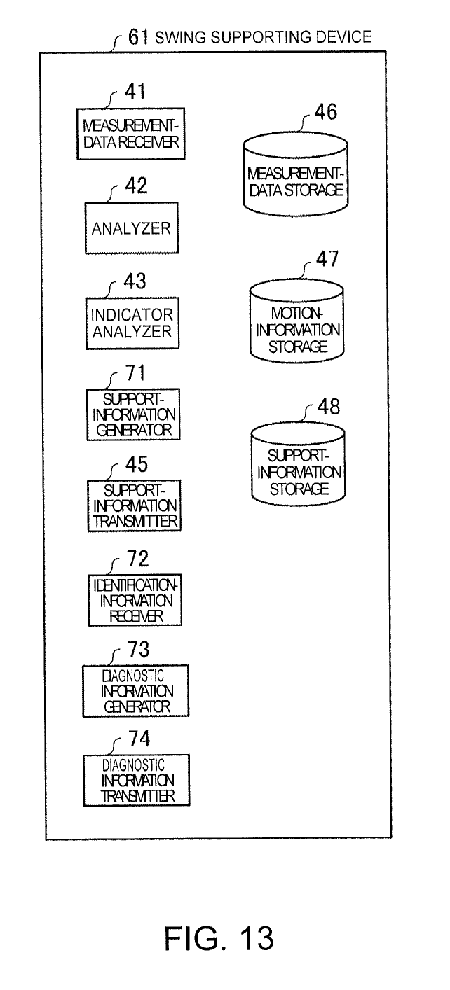

FIG. 13 is a diagram showing an example of functional blocks of the swing supporting device 61. In FIG. 13, sections same as the sections shown in FIG. 3 are denoted by the same reference numerals and explanation of the sections is omitted. As shown in FIG. 13, the swing supporting device 61 includes a support-information generator 71, an identification-information receiver 72, a diagnostic-information generator 73, and a diagnostic-information transmitter (equivalent to the diagnosis-information transmitter according to the invention) 74.

The support-information generator 71 includes user identification information in a swing support information to be generated. The other functions are the same as the functions of the support-information generator 44. The swing support information generated by the support-information generator 71 is transmitted to the swing analyzing device 2 by the support-information transmitter 45.

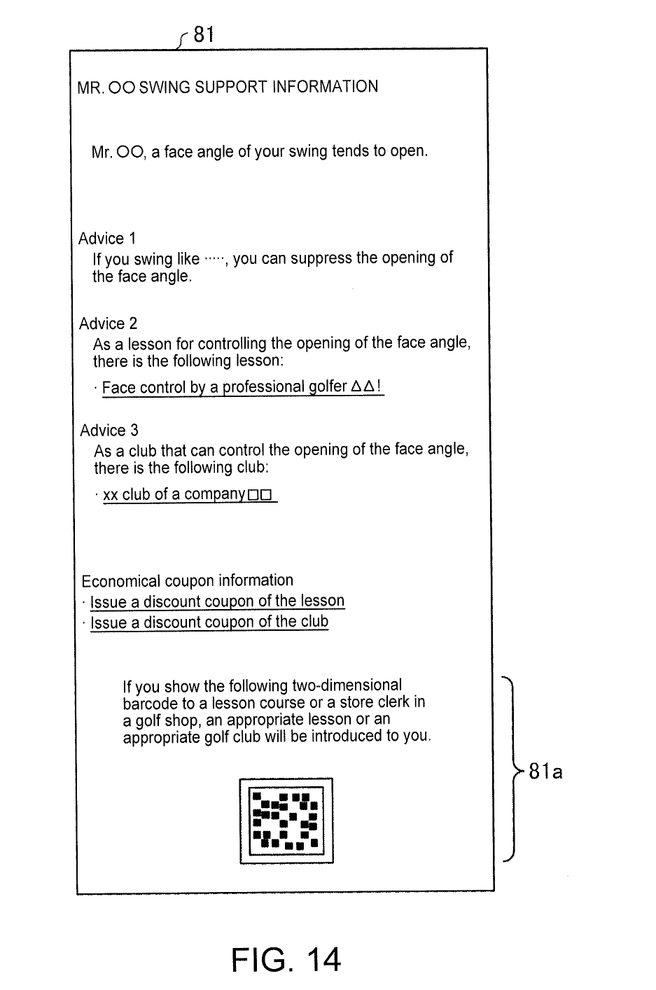

FIG. 14 is a diagram showing a screen example of the swing analyzing device 2. When the swing support information is transmitted from the swing supporting device 3 to the swing analyzing device 2, a screen 81 shown in FIG. 14 is displayed on the display of the swing analyzing device 2.

The screen 81 is the same as the screen 51 explained with reference to FIG. 7. However, the screen 81 is different from the screen 51 in the portion of a region 81a. In the region 81a, a two-dimensional code including the user identification information for identifying the user is displayed.

Referring back to FIG. 13, when the user visits, for example, the lesson professional or the golf shop and holds the two-dimensional code displayed in the swing support information over the reader 63 connected to the terminal device 62 managed by the lesson professional or the golf shop, the user identification information of the user is transmitted from the terminal device 62 to the swing supporting device 61. The identification-information receiver 72 receives the user identification information transmitted from the terminal device 62.

When the user identification information is received by the identification-information receiver 72, the diagnostic-information generator 73 calculates motion information of a swing motion of the user referring to the measurement-data storage 46 on the basis of the received user identification information. The calculation of the motion information is the same as the calculation by the analyzer 42. The diagnostic-information generator 73 generates diagnostic information of the user from the calculated motion information. For example, the diagnostic-information generator 73 generates, on the basis of the calculated motion information, diagnostic information indicating a swing state such as a swing type, head speed, and face angle of the user.

The diagnostic-information transmitter 74 transmits the diagnostic information generated by the diagnostic-information generator 73 to the terminal device 62. The terminal device 62 displays the diagnostic information transmitted from the diagnostic-information transmitter 74 on the display.

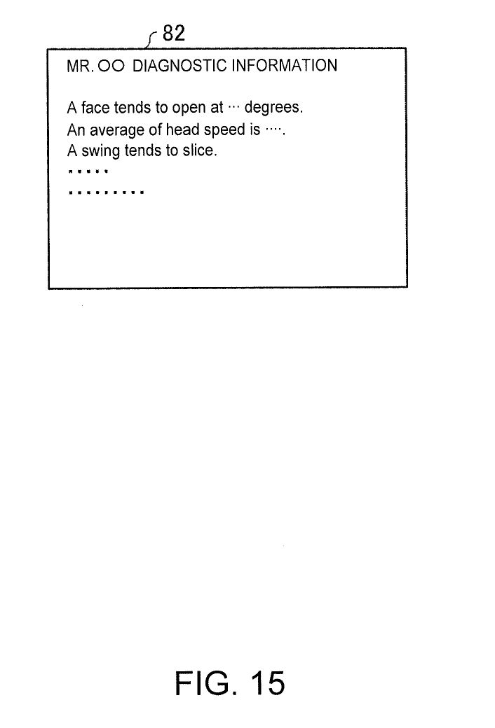

FIG. 15 is a diagram showing a screen example of the terminal device 62. When the diagnostic information is transmitted from the swing supporting device 3 to the terminal device 62 managed by the lesson professional or the golf shop, a screen 82 shown in FIG. 15 is displayed on the display of the terminal device 62.

On the screen 82, the diagnostic information of the user is displayed. For example, on the screen 82, a face angle, head speed, a swing type, and the like of a swing of the user are displayed.

Consequently, for example, the lesson professional can instruct an appropriate lesson corresponding to the user. For example, the store clerk of the golf shop can recommend an appropriate golf club that can improve the swing of the user.

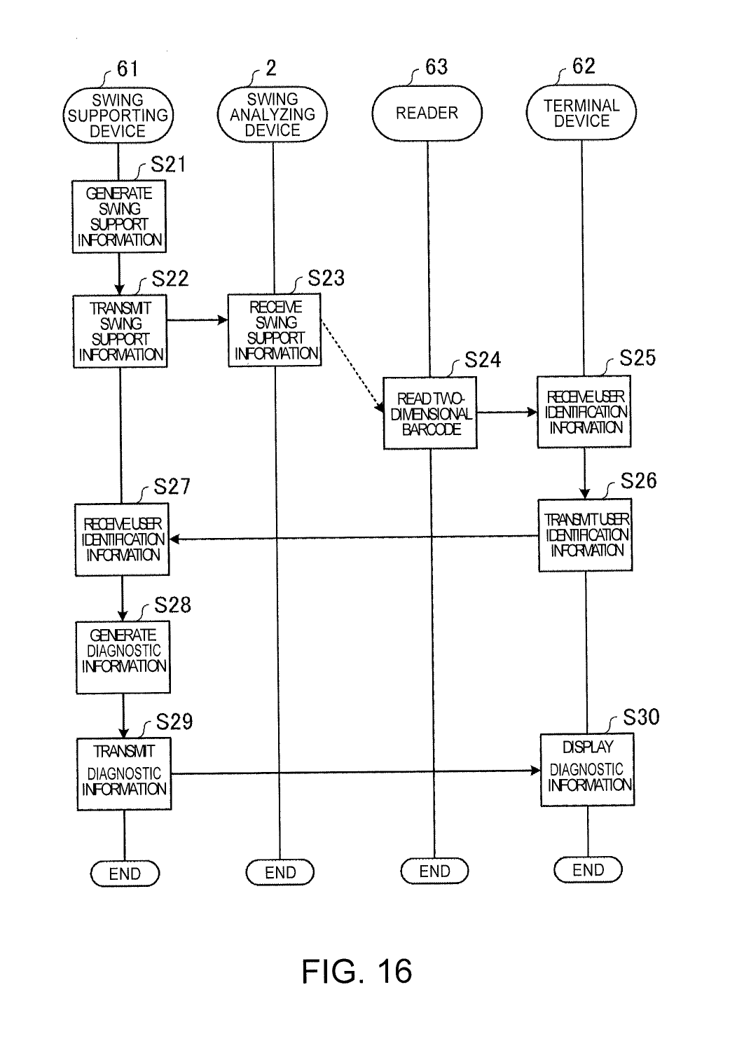

FIG. 16 is a sequence chart showing an operation example of the swing supporting system. When a request for swing support information is received from the user, the analyzer 42 of the swing supporting device 61 analyzes a swing motion of the user. The indicator analyzer 43 analyzes a swing indicator of the user from motion information of the swing motion of the user analyzed by the analyzer 42. The support-information generator 71 generates swing support information including a two-dimensional barcode indicating identification information of the user (step S21).

Subsequently, the support-information transmitter 45 transmits the swing support information generated in step S21 to the swing analyzing device 2 of the user (step S22).

Subsequently, the swing analyzing device 2 receives the swing support information transmitted in step S22 (step S23).

It is assumed that the user visits, for example, the golf shop, causes the display of the swing analyzing device 2 to display the swing support information, and holds the two-dimensional code included in the swing support information over the reader 63 set in the golf shop.

The reader 63 reads the two-dimensional code included in the swing support information and transmits the identification information of the user indicated by the read two-dimensional code to the terminal device 62 (step S24).

Subsequently, the terminal device 62 receives the identification information of the user transmitted in step S24 (step S25).

Subsequently, the terminal device 62 transmits the identification information of the user received in step S25 to the swing supporting device 61 (step S26).

Subsequently, the identification-information receiver 72 of the swing supporting device 61 receives the identification information of the user transmitted in step S26 (step S27).

Subsequently, the diagnostic-information generator 73 calculates motion information of a swing motion of the user referring to the measurement-data storage 46 on the basis of the identification information of the user received in step S27. The diagnostic-information generator 73 generates diagnostic information of the user on the basis of the calculated motion information (step S28).

Subsequently, the diagnostic-information transmitter 74 transmits the diagnostic information generated in step S28 to the terminal device 62 (step S29).

Subsequently, the terminal device 62 receives the diagnostic information transmitted in step S29 and displays the diagnostic information on the display (step S30). Consequently, for example, the store clerk of the golf shop can recommend an appropriate golf club to the user on the basis of the diagnostic information displayed on the display.

In this way, the swing information generated by the swing supporting device 61 includes the user identification information for identifying the user. When the identification-information receiver 72 receives user identification information from the terminal device 62 managed by another person, the diagnostic-information generator 73 generates diagnostic information of a user corresponding to the user identification information. The diagnostic-information transmitter 74 transmits the generated diagnostic information to the terminal device 62. Consequently, the user can appropriately receive information included in the swing support information from the other person.

Note that, in the above explanation, the two-dimensional code is explained as the example of the information indicating the identification information of the user. However, the information may be a barcode or the like.

In the above explanation, the identification-information receiver 72 receives the user identification information from the terminal device 62 managed by the other person. However, the identification-information receiver 72 may receive the user identification information from a terminal device of the user. That is, the terminal device 62 may be the terminal device of the user. The diagnostic-information transmitter 74 may transmit the generated diagnostic information to the terminal device of the user. Consequently, for example, the user can cause the terminal device of the user to display the diagnostic information, present the diagnostic information to the other person, and appropriately receive the information included in the swing support information from the other person.

### Third Embodiment

In a third embodiment, a swing supporting device generates advertisement extraction information for an advertisement related to generated swing support information to be generated in an advertisement delivery server and transmits the advertisement extraction information to the advertisement delivery server. The advertisement delivery server generates an advertisement suitable for a user using, as a clue, the advertisement extraction information transmitted from the swing supporting device and delivers the advertisement to the user.

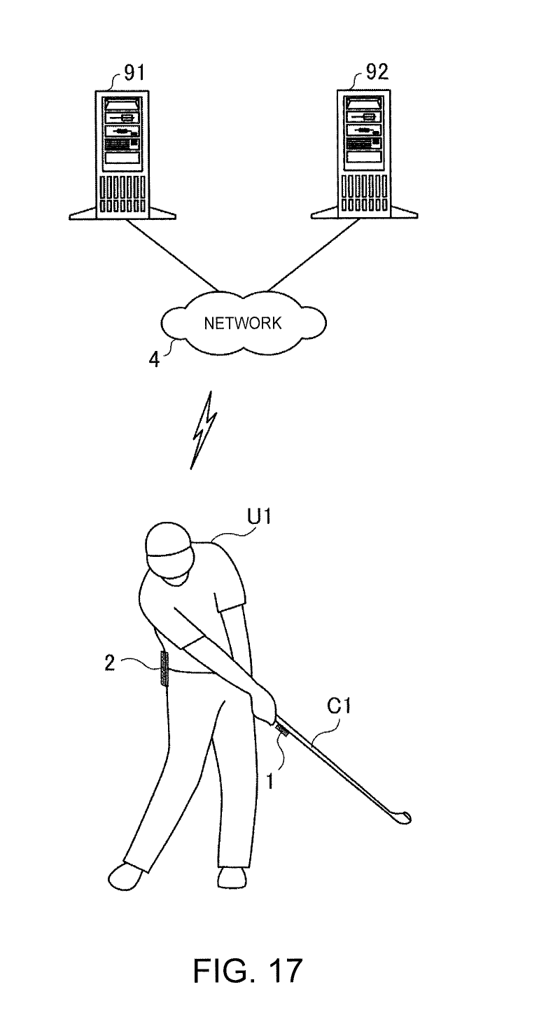

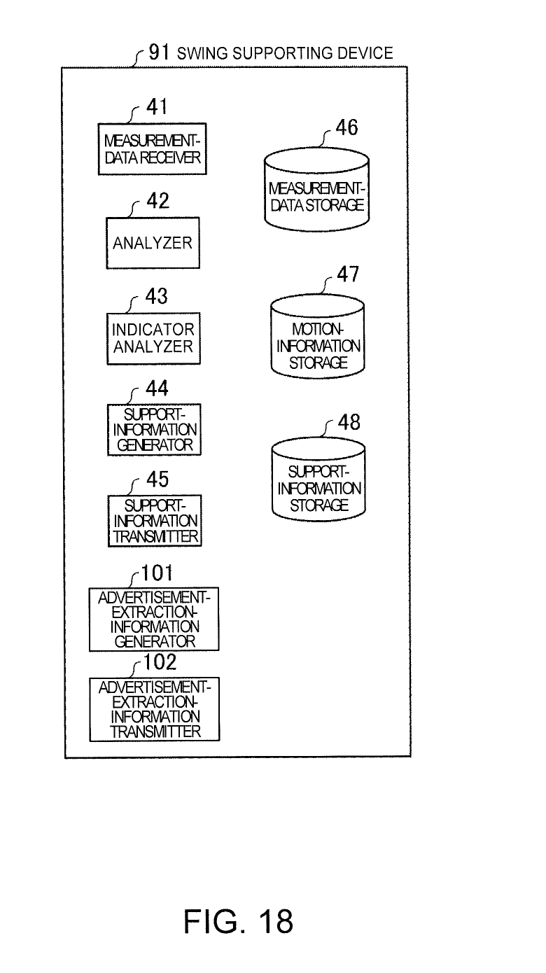

FIG. 17 is a diagram showing a configuration example of a swing supporting system according to the third embodiment. In FIG. 17, devices same as the devices shown in FIG. 1 are denoted by the same reference numerals and signs and explanation of the devices is omitted. In FIG. 17, a swing supporting device 91 and an advertisement delivery server 92 are shown.

The swing supporting device 91 has functions same as the functions of the swing supporting device 3 explained in the first embodiment. However, the swing supporting device 91 generates advertisement extraction information on the basis of generated swing support information and transmits the advertisement extraction information to the advertisement delivery server 92.

The advertisement delivery server 92 generates an advertisement suitable for the user UI using, as a clue, the advertisement extraction information transmitted from the swing supporting device 91. The advertisement delivery server 92 delivers the generated advertisement to the user UI.

FIG. 18 is a diagram showing an example of functional blocks of the swing supporting device 91. In FIG. 18, sections same as the sections shown in FIG. 3 are denoted by the same reference numerals and explanation of the sections is omitted. As shown in FIG. 18, the swing supporting device 91 includes an advertisement-extraction-information generator 101 and an advertisement-extraction-information transmitter 102.

The advertisement-extraction-information generator 101 generates, on the basis of the swing support information generated by the support-information generator 44, advertisement extraction information for a useful advertisement of a user to be generated by the advertisement delivery server 92. For example, it is assumed that swing support information of a certain user generated by the support-information generator 44 includes advice information for suppressing opening of a face angle. In this case, the advertisement-extraction-information generator 101 generates, for example, advertisement extraction information including keywords “face angle opens” and “golf club”.

The advertisement-extraction-information transmitter 102 transmits the advertisement extraction information generated by the advertisement-extraction-information generator 101 and the user information of the user, for whom the advertisement extraction information is generated, to the advertisement delivery server 92. The user information is, for example, a mail address of the user.

The advertisement delivery server 92 generates an advertisement on the basis of the advertisement extraction information transmitted from the advertisement-extraction-information transmitter 102. For example, when the advertisement extraction information includes the keywords “face angle opens” and “golf club”, the advertisement delivery server 92 generates an advertisement of a golf club that can control a face angle. The advertisement delivery server 92 transmits, by mail, the generated advertisement to a mail address destination transmitted from the advertisement-extraction-information transmitter 102.

In this way, the advertisement-extraction-information generator 101 of the swing supporting device 91 generates advertisement extraction information for an advertisement related to the swing support information generated by the support-information generator 44 to be generated. The advertisement-extraction-information transmitter 102 transmits the advertisement extraction information generated by the advertisement-extraction-information generator 101 to the advertisement delivery server 92. Consequently, the advertisement delivery server 92 is capable of delivering an appropriate advertisement to the user for whom the swing support information is generated.

Note that, in the above explanation, the advertisement delivery server 92 delivers the advertisement to the user. However, the advertisement delivery server 92 may transmit the generated advertisement (advertisement information) to the swing supporting device 91. The swing supporting device 91 may receive the advertisement information transmitted from the advertisement delivery server 92 and transmit the advertisement information to a terminal device of the user (e.g., the swing analyzing device 2 of the user).

The invention is explained above with reference to the embodiments. However, the functional components of the swing supporting system explained above are classified according to main processing contents in order to facilitate understanding of the configuration of the swing supporting system. The invention is not limited by a method of the classification and names of the components. The components of the swing supporting system can also be classified into a larger number of components according to processing contents. One component can also be classified to execute a larger number of kinds of processing. The processing of the components may be executed by one kind of hardware or may be executed by a plurality of kinds of hardware.

The processing units of the flowcharts referred to above are divided according to main processing contents in order to facilitate understanding of the processing of the swing supporting system. The invention is not limited by a method of the division and names of the processing units. The processing of the swing supporting system can also be divided into a larger number of processing units according to processing contents. One processing unit can also be divided to include a larger number of kinds of processing. The order of processing is not limited to the flowchart.

The technical scope of the invention is not limited to the scope described in the embodiments. It is evident for those skilled in the art that it is possible to add various changes or improvements to the embodiments. For example, the invention can be applied to swing supporting systems (swing supporting devices) for various sports such as tennis and baseball. It is evident from the description of the appended claims that forms added with such changes or improvements can also be included in the technical scope of the invention. The invention can also be provided as a swing supporting method, a computer program of the swing supporting device, and a storage medium having the computer program stored therein.

The entire disclosure of Japanese Patent Application No. 2015-093409, filed Apr. 30, 2015 is expressly incorporated by reference herein.

What is claimed is:

1. A swing supporting device comprising:
an analyzer configured to analyze a predetermined indicator concerning a swing on the basis of information concerning a swing motion of at least one of an exercise instrument and a user who operates the exercise instrument; and
a selector configured to select, according to a result of the analysis of the indicator, a type of swing support information for supporting a swing of the user and output the type of the swing support information.

2. The swing supporting device according to claim 1, wherein the indicator is at least one of a tendency of the swing, the number of times of the swing, and a practice frequency of the swing per predetermined period.

3. The swing supporting device according to claim 1, wherein the swing support information includes at least one of advice information of the swing, information concerning the exercise instrument suitable for the user, information concerning a practice ground where the user practices the swing, and information concerning a sales store that sells the exercise instrument.

4. The swing supporting device according to claim 1, wherein the selector outputs coupon information as the swing support information when the indicator reaches or exceeds a predetermined threshold.

5. The swing supporting device according to claim 3, wherein the selector outputs coupon information as the swing support information when the indicator reaches or exceeds a predetermined threshold.

6. The swing supporting device according to claim 1, wherein
the swing support information includes identification information for identifying the user, and
the swing supporting device further comprises:
an identification-information receiver configured to receive the identification information from a terminal device of the user; and
a diagnosis-information transmitter configured to transmit, according to the received identification information, diagnosis information corresponding to the identification information to the terminal device of the user.

7. The swing supporting device according to claim 1, further comprising:
an advertisement-extraction-information generator configured to generate advertisement extraction information for extracting an advertisement related to the swing support information; and
an advertisement-extraction-information transmitter configured to transmit the advertisement extraction information to an outside, wherein
the swing supporting device receives advertisement information extracted on the basis of the advertisement extraction information from an outside and outputs the received advertisement information.

8. The swing supporting device according to claim 3, further comprising:
an advertisement-extraction-information generator configured to generate advertisement extraction information for extracting an advertisement related to the swing support information; and
an advertisement-extraction-information transmitter configured to transmit the advertisement extraction information to an outside, wherein
the swing supporting device receives advertisement information extracted on the basis of the advertisement extraction information from an outside and outputs the received advertisement information.

9. A swing supporting method comprising:
analyzing a predetermined indicator concerning a swing on the basis of information concerning a swing motion of at least one of an exercise instrument and a user who operates the exercise instrument; and
selecting, according to a result of the analysis of the indicator, a type of swing support information for supporting a swing of the user and outputting the type of the swing support information.

10. The swing supporting method according to claim 9, wherein the indicator is at least one of a tendency of the swing, the number of times of the swing, and a practice frequency of the swing per predetermined period.

11. The swing supporting method according to claim 9, wherein the swing support information includes at least one of advice information of the swing, information concerning the exercise instrument suitable for the user, information concerning a practice ground where the user practices the swing, and information concerning a sales store that sells the exercise instrument.

12. The swing supporting method according to claim 9, wherein the outputting the type of the swing support information includes outputting coupon information as the swing support information when the indicator reaches or exceeds a predetermined threshold.

13. A storage device having stored therein a computer program for causing a computer to execute:
analyzing a predetermined indicator concerning a swing on the basis of information concerning a swing motion of at least one of an exercise instrument and a user who operates the exercise instrument; and
selecting, according to a result of the analysis of the indicator, a type of swing support information for supporting a swing of the user and outputting the type of the swing support information.

14. A swing supporting system comprising:
the swing supporting device according to claim 1;
an inertial sensor; and
a swing analyzing device configured to analyze, using an output of the inertial sensor, a swing motion of at least one of an exercise instrument and a user who operates the exercise instrument.

15. A swing supporting system comprising:
the swing supporting device according to claim 2;
an inertial sensor; and
a swing analyzing device configured to analyze, using an output of the inertial sensor, a swing motion of at least one of an exercise instrument and a user who operates the exercise instrument.

16. A swing supporting device that analyzes, on the basis of a swing of an exercise instrument of a user, an indicator concerning the swing, selects, according to a result of the analysis of the indicator, a type of swing information concerning the swing of the user, and outputs the swing information of the selected type.

17. The swing supporting device according to claim 16, wherein the indicator is at least one of a tendency of the swing, the number of times of the swing, and a practice frequency of the swing per predetermined period.

18. The swing supporting device according to claim 16, wherein the swing support information includes at least one of advice information of the swing, information concerning the exercise instrument suitable for the user, information concerning a practice ground where the user practices the swing, and information concerning a sales store that sells the exercise instrument.
